(19) United States
(12) Patent Application Publication
(10) Pub. No.: US 2004/0173554 A1
(43) Pub. Date: Sep. 9, 2004

(54) Industrial truck

(76) Inventor: Peter Eiler, Oldenburg (DE)

Correspondence Address: WILLIAM COLLARD, COLLARD & ROE, P.C., 1077 NORTHERN BOULEVARD, ROSLYN, NY, 11576, US

(21) Appl. No.: 10/480,027

(22) PCT Filed: Jun. 6, 2002
(86) PCT No.: PCT/DE02/02066

(30) Foreign Application Priority Data
Jun. 8, 2001 (DE) 101 27 964.7

(51) Int. Cl. B66C 23/26

(52) U.S. Cl. 212/294

(57) ABSTRACT

The invention relates to an industrial truck comprising a gantry-type, high-rise wheeled chassis and at least one lifting device (15) for loads that can be picked up and transported between the wheels (5, 6). Said chassis consists of at least one first front travelling frame (1) and at least one second rear travelling frame (2). Each travelling frame (1, 2) is configured as a gantry consisting of vertical stanchions with articulated wheels at their base and a cross brace (7, 8) that interconnects the heads of the stanchions (3, 4). Each travelling frame has a connection assembly (9, 10), which projects towards the respective opposite travelling frame, the free end (11, 12) of each connection assembly being connected to the respective opposite travelling frame by means of articulations (13). Each connection assembly (9, 10) resembles a triangular boom or jib with a horizontal brace (31) and a diagonal brace (32). The respective heads of the horizontal brace and diagonal brace are connected one above the other to stanchion sections (35) of the cross brace and the free ends lying opposite the heads (33, 34) converge into the corresponding articulation (13), for connection to the respective opposite travelling frame.

The invention relates to an industrial truck comprising a gantry-type, high-rise wheeled chassis, which has at least one lifting device for loads that can be picked up and transported between the wheels of the truck.

Industrial trucks of the type indicated above are used for the transport of heavy piece goods, for example such goods weighing 20 metric tons. Gantry-type, high-rise chassis have multiple legs, in most cases, generally four legs. The wheels are located on the bottom ends of the legs of a gantry-type chassis, thereby making the chassis multi-wheeled, or four-wheeled, respectively.

When the pavement is uneven, it can happen that one or more wheels lose contact with the floor, in other words contact with the pavement surface. The transport of heavy piece goods is made unsafe by this, particularly if not all the wheels are configured as drive wheels, and if the drive wheels are the ones that lose floor contact. However, providing an all-wheel drive is complicated and costly, and also increases the curb weight of the truck in disadvantageous manner.

The invention is based on the task of making available an industrial truck, the chassis wheels of which do not lose floor contact in case of unevenness of the floor.

This task is accomplished by means of the characteristics of claim 1. Advantageous further developments of the invention result from the dependent claims 2 to 17. It is essential to the invention that the chassis consists of at least one first front traveling frame and at least one second rear traveling frame, that each traveling frame is configured as a gantry consisting of vertical stanchions having articulated wheels at their base, and a crosshead that interconnects the heads of the stanchions, and that each traveling frame has a connection assembly that projects towards the respective opposite traveling frame, whereby the free end of each connection assembly is connected with the respective opposite traveling frame by means of articulations. The chassis of the industrial truck according to the invention therefore consists of at least two single-axle trucks, namely the first traveling frame and the second traveling frame, which are placed one behind the other, in such a manner that their wheels run in the same track, in each instance. Each traveling frame and therefore each individual truck is connected with the other traveling frame, i.e. the other individual truck, by means of the projecting connection assembly, whereby the length of the connection assembly determines the distance between the single-axle trucks. With reference to a single-axle truck as described above, the connection assemblies form their side drawbars.

The system of a chassis as described above, while providing sufficient carrying capacity for loads to be carried, offers the advantageous resilience of the articulations, which ensure that none of the wheels loses contact with the floor during the traveling movement of the industrial truck. This is not only advantageous for the drive, but also for the steering.

Because of the construction principle for the chassis as described above, the truck has only a relatively low inherent weight.

By means of a corresponding multiple arrangement of the traveling frames, it is easily possible to compose six-wheeled and eight-wheeled trucks, as well. In particular, chassis having a tandem arrangement or a multi-axle arrangement are also possible.

It is particularly advantageous if the gantry height of each traveling frame can be changed. This is achieved, in terms of design, in that each stanchion consists of telescoping stanchion sections. For example, bottom stanchion sections are contained in top stanchion sections, in such a manner that they can be moved in length, and drive means for controlled lengthwise displacement are provided. The top stanchion end sections, together with a crossbar that connects them, form an approximately U-shaped component that serves as the crosshead of each traveling frame. The bottom stanchion sections each hold and guide a wheel, i.e. the wheels of the truck. Each crosshead of each traveling frame, as a structural unit, is in turn held on the bottom stanchion sections so that it can be displaced lengthwise, for example in that top stanchion sections that are an integral part of the crosshead hold the bottom stanchion sections with a positive lock, and are guided on them in displaceable manner.

Working cylinders, particularly hydraulic cylinders, are preferably suitable as drive means for such displacement.

Upon activation of the drive means that are present as working cylinders for the lengthwise displacement, the portal height changes, so that the truck can pass through doors of work buildings, for example, if necessary, if these doors have a relatively low pass-through height.

Of course it is also possible to utilize the height adjustment of the crossheads by means of the drive means in order to lift or lower loads, or to assist in this by providing part of the work. In such a case, the drive means for the lengthwise displaceability would also be components of the lifting device.

In the industrial truck according to the invention, however, at least one running rail suspended from the crossbars of the crossheads is provided, for at least one trolley. Each trolley can have a corresponding lifting device assigned to it, for example a winch. It is particularly advantageous if the length of the running rail is greater than the distance between the traveling frames, which is dependent on the projection of the connection assemblies. If two trolleys that can be activated independent of one another are arranged on the running rail, the working range of the trolleys can advantageously be extended to regions that lie in front of or behind the traveling frame, into which regions the excess length of the running rail projects.

The connection assemblies are located, in each instance, on the stanchion sections that participate in forming the U-shaped crosshead. Because of the lengthwise displaceability of these stanchion sections, as described above, the connection assemblies are thereby lifted or lowered along with the crosshead when the gantry height is changed, by extending or retracting the crosshead. The compulsory movements of all the stanchion sections that can be displaced lengthwise run parallel, whereby the running rail that also participates in forming the lifting device is lifted or lowered at the same time with the trolleys.

Each connection assembly is configured similar to a triangular boom or jib, whereby the respective heads of the horizontal brace and the diagonal brace are connected with the crosshead, in each instance, and the free ends that lie opposite the heads converge in the corresponding articulation, for a connection to the other traveling frame, in each instance.

It is also possible to draw a console-like profile that runs parallel to the stanchion section in between the heads of the diagonal brace and the horizontal brace, so that each connection assembly with the horizontal brace and the diagonal brace as well as the console-like profile has the shape of a triangle, particularly of a right triangle. Even without the console-like profile, the horizontal brace, the diagonal brace, and the respective stanchion section, in each instance, form an approximately right triangle.

Each connection assembly is connected with the respective heads of the horizontal brace and the diagonal brace on the corresponding stanchion segment, from which it projects, by means of pivot bearings that can be moved relative to the vertical axis. The free ends of the connection assemblies can thereby perform pivoting movements about a vertical axis of rotation, which runs parallel to the vertical longitudinal axis of a corresponding stanchion segment. This allows the chassis to be flipped from an operating position into a transport position having a lesser track width, as will still be explained below.

The softness of the construction of the chassis for the industrial truck that is the deciding factor for equalizing unevenness of the floor is achieved in that each articulation for connecting the free end of the connection assembly, in each instance, with stanchion sections of the other traveling frame, in each instance, is configured as a ball joint that can be moved at a right angle to the axis of rotation that runs perpendicular and, in addition, about a vertical axis.

So that tracking accuracy of the travel frame results in the operating position of the chassis, it is particularly advantageous if an additional reinforcement that makes the pivot bearing ineffective is provided on the industrial truck according to the invention, in that each traveling frame is equipped with a corner brace arranged between its crosshead and the connection assembly articulated on it. In this connection, it is particularly advantageous if each corner brace is releasably held on the crosshead and/or the connection assembly. This makes it possible to pivot the crossheads into a predetermined angle relative to the longitudinal axis of the truck when the corner brace is released, thereby reducing the track width of the industrial truck in advantageous manner. The industrial truck can therefore be brought into the transport position, and back into the operating position by spreading the corner braces out and fixing them in place, in simple manner.

The corner braces can be releasably held in place by means of socket pins, screw connections, or the like.

Of course a controllable mechanism could also be used, which takes over the function of the corner braces, but is advantageously configured in optional manner, in order to bring the industrial truck from the operating position into the transport position, and vice versa, without any prior fitting and assembly work.

Because the heads and the free ends of each connection assembly move about vertical axes that run parallel to the longitudinal axes of the stanchion sections, in each instance, during diagonal pivoting of the crossheads when a change-over from the operating position into the transport position takes place, forces are exerted on the suspension of the running rail of the lifting device, which can only be equalized by the fact that according to the invention, each suspension of a running rail on the crossbars of the crossheads of the traveling frame is structured as a suspension that can be varied in the horizontal plane. With the variable suspensions, it is possible to shift the running rail, which normally hangs precisely in the center of the crosshead, to the side. This can also be advantageous during manipulations of the loads that are suspended from the running rail, particularly if each variable suspension has setting elements for setting or changing the suspension point on the crossbar, in each instance, and/or on the running rail.

Again, the setting elements can comprise working cylinders, preferably hydraulic cylinders, which can be activated by way of appropriate controls.

An exemplary embodiment of the invention, which shows other inventive characteristics, is shown in the drawing. This shows:

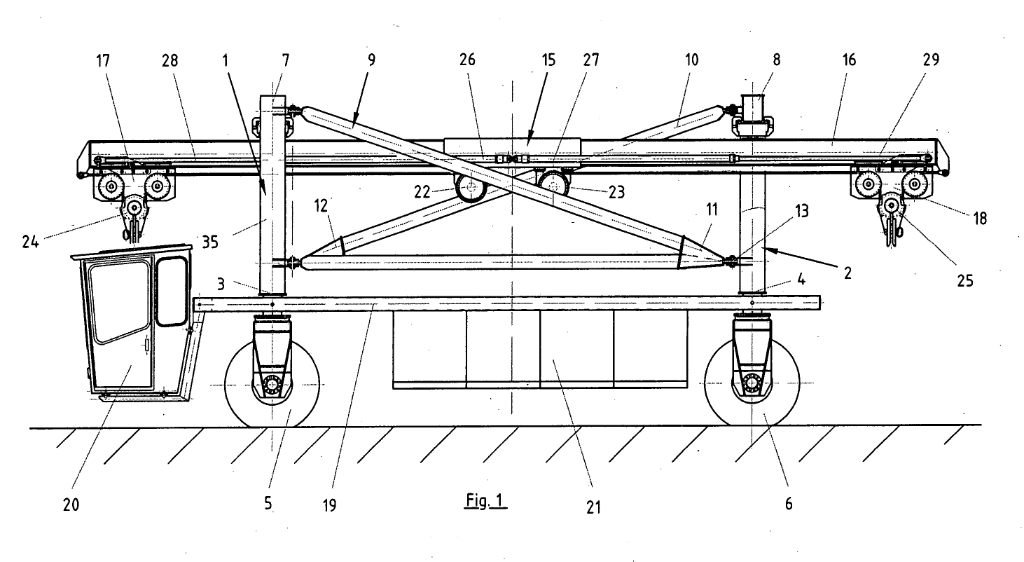

FIG. 1 a side view of the industrial truck,

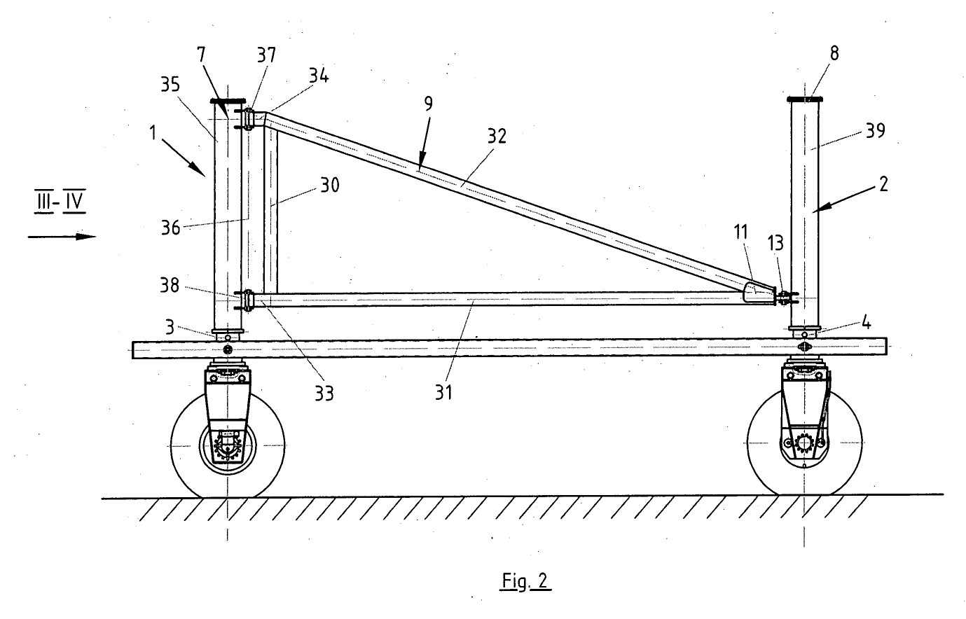

FIG. 2 a schematic overview of the chassis of the industrial truck according to FIG. 1, consisting of two traveling frames, viewed from the side,

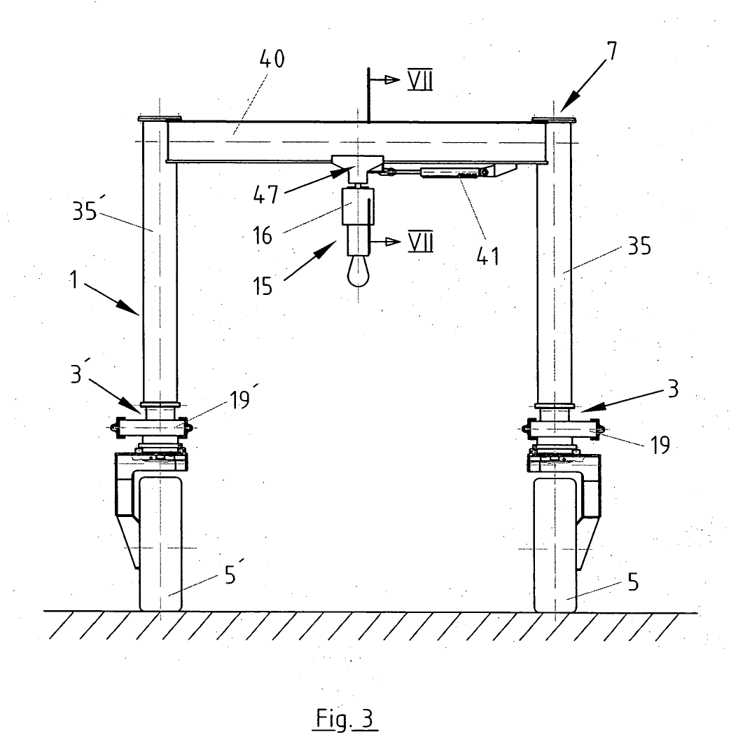

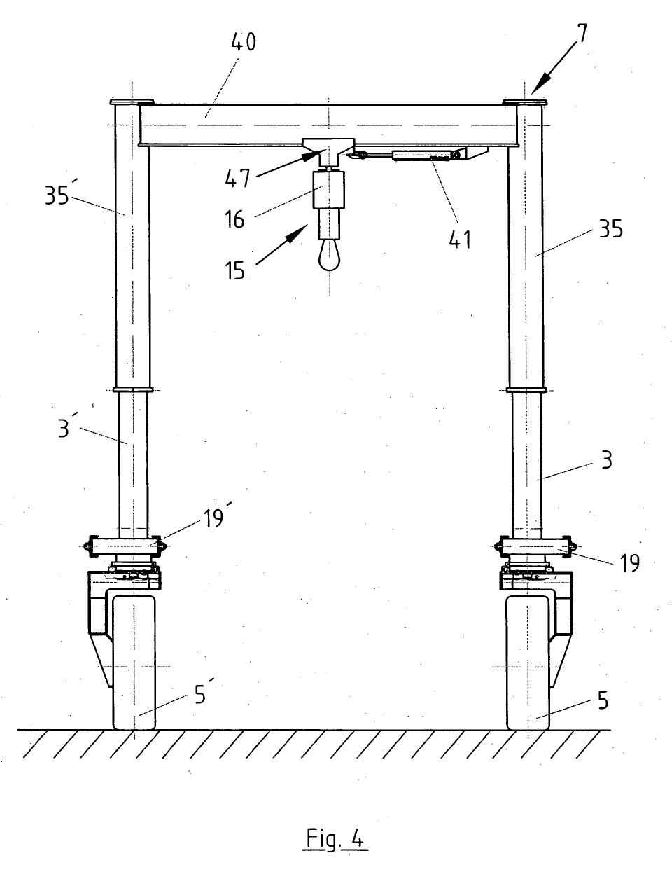

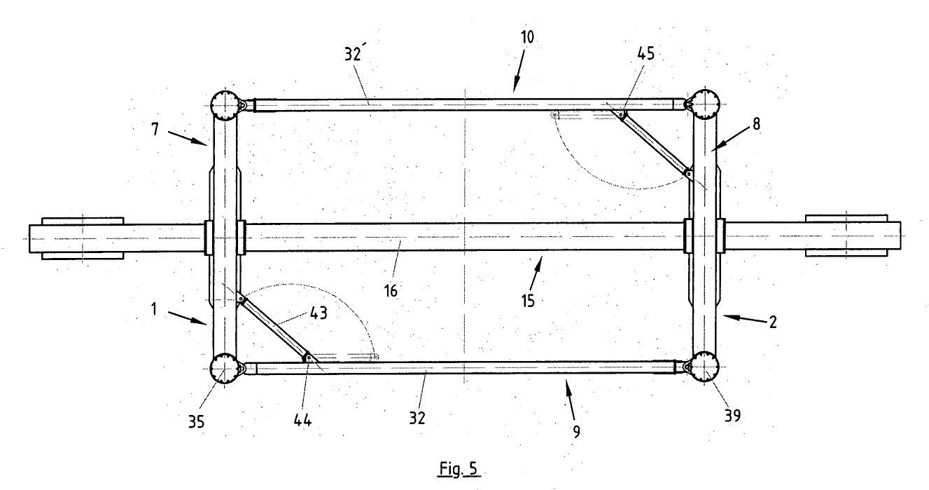

FIG. 3 a view of a traveling frame of the chassis, viewed in the direction of the arrow III in FIG. 2,

FIG. 4 a view of the traveling frame of the chassis, viewed in the direction of the arrow IV in FIG. 2, whereby stanchion sections have been moved lengthwise as compared with FIG. 3, thereby resulting in a greater gantry height,

FIG. 5 a schematic top view of the industrial truck, with a lifting device, in the operational position,

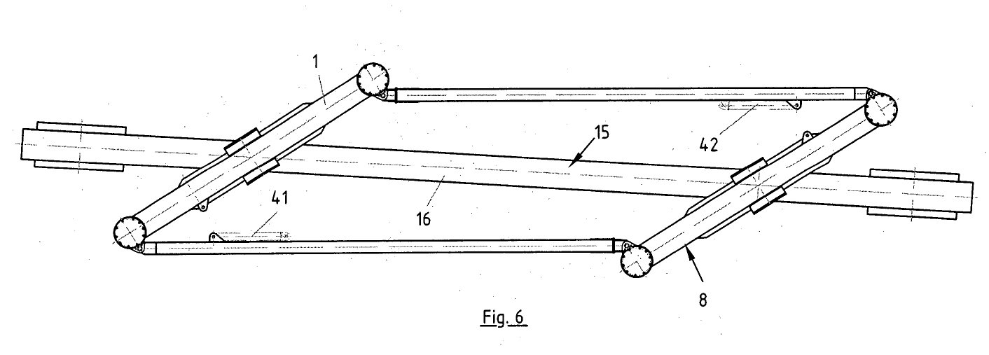

FIG. 6 a top view of the chassis, corresponding to FIG. 6, in the transport position,

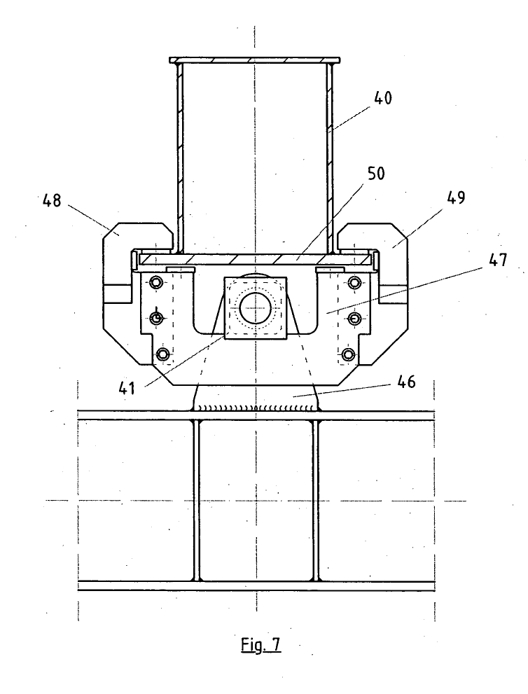

FIG. 7 a detail view of a crossbar of a crosshead, with the running rail of the lifting device suspended from it, in cross-section approximately along the line VII-VII in FIG. 3,

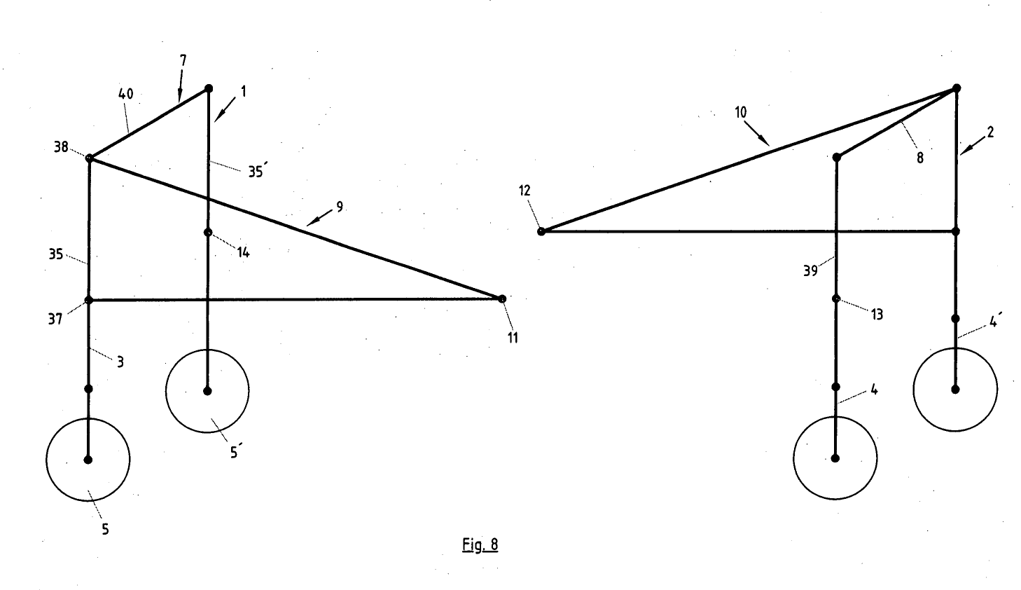

FIG. 8 a fundamental representation of the chassis, formed by two individual single-axle trucks, each having a side drawbar that projects on one side, in triangular shape, forming a connection assembly, in each instance,

FIG. 9 a schematic view of the design principle according to FIG. 8, but in the state of the single-axle trucks joined together to form a chassis,

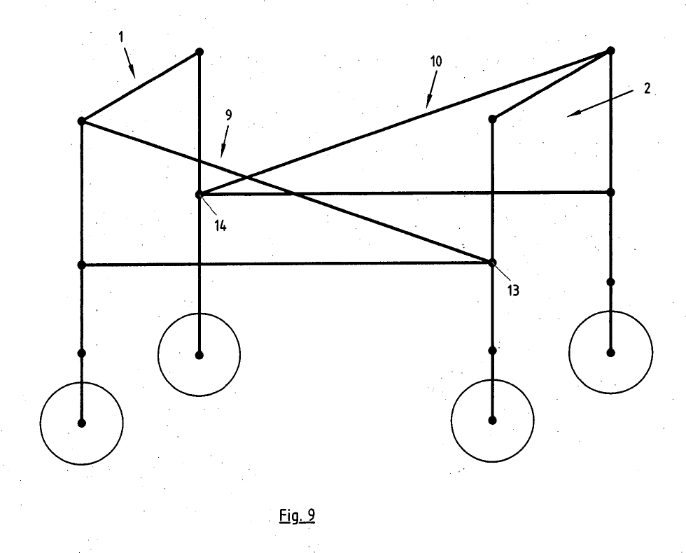

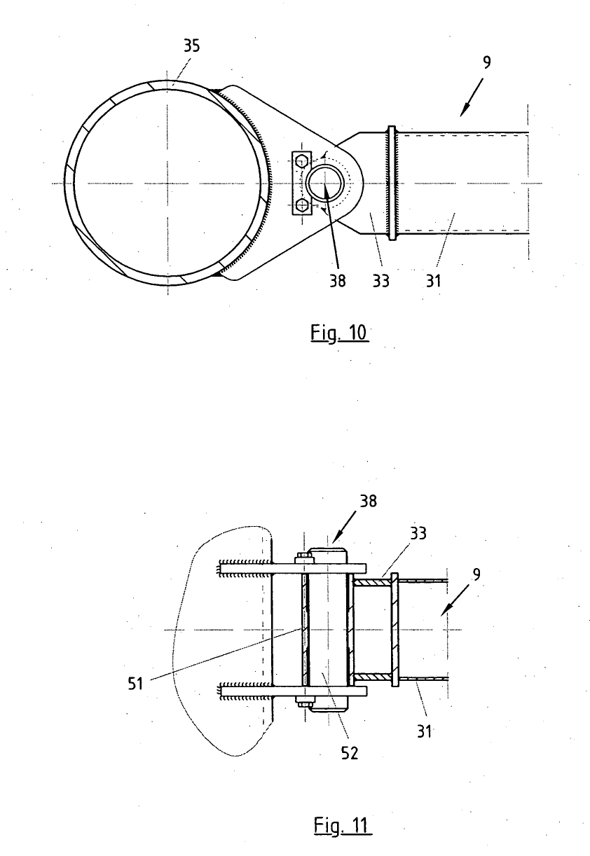

FIG. 10 the articulated connection of a connection assembly with a stanchion of the chassis, by means of pivot bearings, in a top view,

FIG. 11 a side view of the pivot bearing according to FIG. 10, in cross-section,

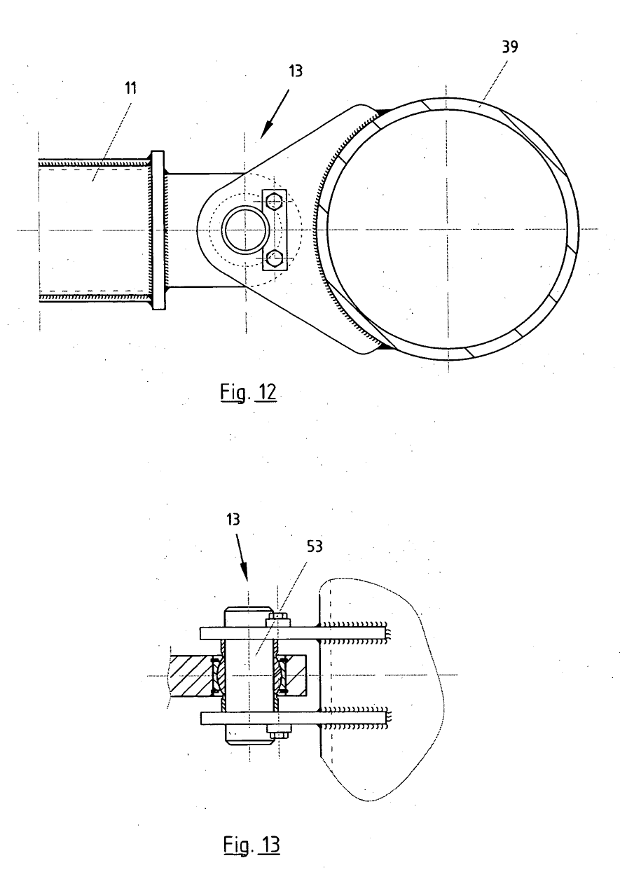

FIG. 12 the articulated connection of the free end of the connection assembly with a stanchion, by means of a ball joint, and

FIG. 13 the articulated connection according to FIG. 12, in cross-section.

FIG. 1 shows the industrial truck having a gantry-type high-rise chassis schematically, in a side view. FIG. 1 makes it clear that the chassis of the industrial truck consists of a first front traveling frame 1 and a second rear traveling frame 2. Each traveling frame 1, 2 is configured as a gantry that consists of vertical stanchions 3, 4 having articulated wheels 5, 6 at their base, and a crosshead 7, 8 that interconnects the heads of the stanchions 3, 4, i.e. sections of the stanchions intended for this purpose, in each instance. Each traveling frame 1, 2 has a connection assembly 9 or 10, respectively, whereby the free end 11 or 12, respectively, of each connection assembly 9 or 10, respectively, is connected with the other traveling frame 2 or 1, respectively, by way of articulations. The free end 11 of the connection assembly 9 is consequently connected with the traveling frame 2 by way of the articulation 13 that can be seen here, while the connection assembly 10, which is located on the side of the industrial truck shown here that is set to the bottom, i.e. to the back relative to the plane of the drawing, and therefore cannot be seen here, is connected with the traveling frame 1 with its free end 12, by way of the articulation 14 that is covered here (see also FIG. 8 and 9).

A lifting device that is configured as a running rail 16 for two trolleys 17 and 18, aligned parallel with the longitudinal axis of the industrial truck, is suspended from the crossheads 7 and 8 of the traveling frames 1 and 2, which extend crosswise to the plane of the drawing.

A lengthwise support that carries a driver's cabin 20 on the front of the truck is referred to as 19; it also serves as a motor carrier in the center of the truck, in that it carries the respective drive and control units 21, which are only shown schematically here. Furthermore, the working cylinders that apply the steering forces to the wheels 5, 5′ are supported on the lengthwise support 19.

The lifting device 15 is provided with winch assemblies 22 and 23, which are assigned to the cables for hook pulleys 24 and 25, in usual manner. The trolleys 17 and 18 can be displaced or moved along the running rail 16 of the lifting device 15 by means of extra-long working cylinders 26 and 27, the piston rods 28 and 29 of which engage with the trolleys 17 and 18, in each instance.

FIG. 2 shows a schematic side view of the chassis and makes it clear that each connection assembly, here in FIG. 2 as a connection assembly 9 which, in deviation from the connection assembly that can be seen in FIG. 1, is also equipped with a console profile 30, is configured similar to a jib or a boom, with a horizontal brace 31 and a diagonal brace 32, whereby the respective heads 33 and 34 of the horizontal brace 31 and the diagonal brace 32, one on top of the other, are connected to stanchion sections 35 of the crosshead, with pivot bearings 37 and 38 that are movable relative to the vertical axis 36. Each articulation 13 for connecting the free end 11 of the connection assembly 9 to the stanchion sections 39 of the traveling frame 2, which participate in forming the crosshead 8, is configured as a ball joint that can be moved about an axis of rotation that runs at a right angle to the vertical and, in addition, about a vertical axis, as will be explained in greater detail below.

FIG. 3 shows a view in the direction of the arrow III in FIG. 2, and makes it clear that each traveling frame, such as the traveling frame 1 that can be seen here, is configured like a gantry.

Each gantry-type traveling frame consists of the vertical stanchions 3 and 3′, with articulated wheels 5 and 5′ at their base. The heads of the stanchions 3 and 3′ are connected by means of an approximately U-shaped crosshead 7.

Each stanchion 3 or 3′ in turn consists of telescoping stanchion sections, whereby each crosshead of each traveling frame, as is the case for the crosshead 7 that can be seen here, forms an approximately U-shaped component, which is formed here by two top stanchion sections 35 and 35′ and a crossbar 40 that connects the stanchion sections 35 and 35′. Lengthwise supports 19 and 19′ are not involved in the statics of the wheeled chassis of the industrial truck according to the invention, or are only involved to an insignificant extent. They mainly serve to absorb steering forces, which are exerted by working cylinders that act on the pivoted bogie with the wheels 5, 5′.

The stanchion sections 35 and 35′ of the crosshead 7 are configured as hollow profiles in which bottom sections of the stanchions 3 and 3′ of the traveling frames are held. By means of drive means that are not shown in detail, controlled lengthwise displacement of the stanchion sections relative to one another is possible, so that the gantry height of the traveling frame can be changed by means of lifting or lowering the crosshead 7. This applies analogously for the crosshead 8 of the second traveling frame 2.

FIG. 4 shows a view of the chassis in the direction of the arrow IV in FIG. 2, whereby the stanchion sections have been moved lengthwise as compared with FIG. 3, thereby resulting in a greater gantry height. The same components have been numbered with the same reference numbers.

Both FIG. 3 and FIG. 4 furthermore illustrate that the lifting device 15 can be moved along the crossbar 40, whereby a movement during displacement takes place by means of a setting element 41, which is configured as a working cylinder here, along the crossbar 40. The suspension of the running rail 16 on the crossbar 40 of the crosshead 7 is therefore configured as a suspension that can be varied in the horizontal plane.

The suspension on the crosshead 8 is configured in the same manner.

FIG. 5 shows the chassis in a schematic top view, whereby the individual traveling frames 1 and 2 as well as the corresponding connection assemblies 9 and 10 and the running rail of the lifting device 15, which is suspended from the crossheads 7 and 8, can be seen.

FIG. 5 illustrates that each traveling frame 1 or 2, respectively, is equipped with a corner brace 42 and 43 between its crosshead 7 or 8, respectively, and the connection assembly 9 or 10, respectively, which is connected with it in articulated manner. Each corner brace 42 and 43 is a bar that is releasably held on the crosshead 7 or 8 and/or the connection assembly 9 or 10. In this exemplary embodiment, the end of the corner brace 43 that is connected with the crosshead 7 is releasable, and can be pivoted about the attachment point 44, against the diagonal brace 32 of the connection assembly 9, after it has been released. In the same manner, the corner brace 43 can be flipped about the attachment point 45, against the diagonal brace 32′ of the connection assembly 10.

After the corner braces 42 and 43 have been released, the traveling frames, i.e. their crossheads can be pivoted into the diagonal position shown in FIG. 6, whereby the construction width, i.e. track width of the industrial truck is reduced. The components of the industrial truck have thereby assumed an advantageous transport position. In order to be able to achieve this transport position, the use of the variable suspension of the running rail 16 of the lifting device 15 is necessary, in that a change in the suspension point on the crossbar and/or on the running rail takes place by means of the setting elements.

FIG. 7 shows a detail view of a crossbar 40 of a crosshead, with a running rail 16 suspended from it in variable manner, in a cross- section along the line VII-VII in FIG. 3, whereby an embodiment possibility for a variable suspension of the running rail 16 is indicated. The running rail is suspended, by a tab 46, on a guide sled 47, which in turn engages with a bottom, widened flange 50 of the crossbar 40 that is configured as a box beam, with its slide claws 48 and 49, and is configured in such a manner that the guide sled 47, and thereby also the running rail 16 of the lifting device 15 that is suspended from it, can be pushed or adjusted crosswise to the plane of the drawing, along the crossbar 40, using the working cylinder that serves as a setting element 41 (FIG. 4).

FIGS. 8 and 9 are fundamental representations of the method of construction of the chassis, whereby it can be clearly seen that each traveling frame 1 or 2 is an individual single-axle truck having a projecting drawbar in the shape of a triangle on one side. The drawbars form the connection assemblies 9, 10, which project from the left traveling frame 1 towards the right traveling frame 2, and vice versa. In the case of the left traveling frame 1, the crosshead 7 is formed from the stanchion sections 35 and 35′ (see also FIG. 3), which are connected, at their heads, by the crossbar 40, so that a first U-shaped component, the crosshead 7, is formed. On the stanchion section 35, the heads of the connection assembly 9 that projects from the traveling frame 1 are connected with pivot bearings 37 and 38 that can be moved relative to the vertical axis. The free end 11 of the connection assembly 9 is connected with the stanchion section 39 of the crosshead 8 of the second traveling frame 2, in other words the second single-axle truck, by way of an articulation 13. The free end 12 of the connection assembly 10 that projects from the second traveling frame 2 in turn is connected with the stanchion section 35′ of the crosshead 7 of the left traveling frame 1, by way of an articulation 14.

This is evident from FIG. 9, in which the construction principle of the chassis having the two traveling frames 1 and 2 with their projection connection assemblies 9 and 10, in each instance, is shown schematically once again.

FIG. 10 shows an embodiment possibility for the articulated connection of a connection assembly 9 with a stanchion section 35, by means of a pivot bearing. It can be seen how the head 33 of the horizontal brace 31 of the connection assembly 9 (FIG. 1 and FIG. 2) is connected with the stanchion section 35 by way of a pivot bearing 38.

In FIG. 11, the pivot bearing 38 is shown once again, in cross- section. FIG. 11 shows that the head 33 is mounted on the bearing bolt 52 of the pivot bearing 38 with a bushing 51.

FIG. 12 shows the articulated connection of the free end 11 of the connection assembly 9 with the stanchion section 39, which is an integral part of the crosshead 8, by way of an articulation 13. The articulation 14 for connecting the connection assembly 10 is configured in similar manner.

FIG. 13 is a cross-sectional view of the embodiment of the articulation 13 and shows that the articulation 13 is configured as a ball joint, which allows movements that can be performed both about an axis of rotation 53 that runs at a right angle to the vertical and, in addition, about a vertical axis.

1. Industrial truck comprising a gantry-type, high-rise wheeled chassis, which has at least one lifting device for loads that can be picked up and transported between the wheels of the truck, characterized in that
the chassis consists of at least one first front traveling frame (1) and at least one second rear traveling frame (2),
that each traveling frame (1, 2) is configured as a gantry consisting of vertical stanchions (3, 3′, 4) having articulated wheels (5, 5′) at their base, and a crosshead (7, 8) that interconnects the heads of the stanchions (3, 3′, 4), and
that each traveling frame (1) has a connection assembly (9, 10) that projects towards the respective opposite traveling frame (2),
whereby the free end (11, 12) of each connection assembly (9, 10) is connected with the respective opposite traveling frame (1, 2) by means of articulations (13, 14).

2. Industrial truck according to claim 1, characterized in that each stanchion (3, 3′, 4) consists of telescoping stanchion sections (35, 35′, 39).

3. Industrial truck according to one of claims 1 and 2, characterized in that the crosshead (7, 8) of each traveling frame (1, 2) is an approximately U-shaped component, which is formed by two top stanchion sections (35, 35′) and a crossbar (40) that connects the top stanchion sections (35, 35′).

4. Industrial truck according to claim 3, characterized in that the top stanchion sections (35, 35′, 39) hold the bottom sections of the stanchions (3, 3′, 4) so that they can be displaced lengthwise, and that drive means are provided for controlled lengthwise displacement.

5. Industrial truck according to claim 4, characterized in that the drive means are working cylinders, particularly hydraulic cylinders.

6. Industrial truck according to one of claims 1 to 5, characterized in that each connection assembly (9, 10) projects from one of the top stanchion sections (35, 35′, 39) of the travel frame (1, 2), in each instance.

7. Industrial truck according to one the preceding claims, characterized in that at least one running rail (16) suspended from the crossbars (40) of the crossheads (7, 8) is provided, for at least one trolley (17, 18), as the lifting device (15).

8. Industrial truck according to claim 7, characterized in that the length of the running rail (16) is greater than the distance between the traveling frames (1, 2), which is dependent on the projection of the connection assemblies (9, 10).

9. Industrial truck according to one of claims 7 and 8, characterized in that two trolleys (17, 18) that can be activated independent of one another are guided on the running rail (16).

10. Industrial truck according to one of the preceding claims, characterized in that each connection assembly (9, 10) is configured similar to a boom or jib, having a horizontal brace (31) and a diagonal brace (32, 32′), whereby the respective heads (33, 34) of the horizontal brace (31) and the diagonal brace (32, 32′) are connected, one on top of the other, with stanchion sections (35, 35′, 39) of the crosshead (7, 8), and the free ends (11, 12) that lie opposite the heads (33, 34) converge in the corresponding articulation (13, 14), for a connection to the other traveling frame (1, 2), in each instance.

11. Industrial truck according to claim 10, characterized in that each connection assembly (9, 10) is connected to the respective stanchion section (35, 39) from which it projects, with pivot bearings (37, 38) that are movable in the vertical axis.

12. Industrial truck according to claim 11, characterized in that each articulation (13, 14) for connecting the free end (11, 12) of the connection assembly (9, 10), in each instance, to the stanchion sections (35, 39) of the other traveling frame (1, 2), in each instance, is configured as a ball joint that can be moved about an axis of rotation (33) that runs at a right angle to the vertical and, in addition, about a vertical axis.

13. Industrial truck according to one of claims 1 to 12, characterized in that each traveling frame (1, 2) is equipped with a corner brace (42, 43) that is arranged between its crosshead (7, 8) and the connection assembly (9, 10) articulated on it.

14. Industrial truck according to claim 13, characterized in that each corner brace (42, 43) is releasably held on the crosshead (7, 8) and/or on the connection assembly (9, 10).

15. Industrial truck according to one of the preceding claims, characterized in that the suspension of the running rail (16) on the crossbars (40) of the crossheads (7, 8) is configured as a suspension that can be varied in the horizontal plane.

16. Industrial truck according to claim 15, characterized in that each variable suspension has setting elements (41) for setting or changing the suspension point on the crossbar (40), in each instance, and/or on the running rail (16).

17. Industrial truck according to claim 16, characterized in that the setting elements (41) comprise working cylinders that displace the suspension.
